(19) United States
(12) Patent Application Publication
(10) Pub. No.: US 2023/0267318 A1
(43) Pub. Date: Aug. 24, 2023

(54) NEUROMORPHIC SYSTEM FOR IMPLEMENTING SPIKE TIMING DEPENDENT PLASTICITY OPERATION

(71) Applicant: Korea Institute of Science and Technology, Seoul (KR)

(72) Inventors: Joon Young KWAK, Seoul (KR); Sung Yun PARK, Seoul (KR); Min Jee KIM, Seoul (KR); Su Youn LEE, Seoul (KR)

(73) Assignee: Korea Institute of Science and Technology, Seoul (KR)

(21) Appl. No.: 17/872,558

(22) Filed: Jul. 25, 2022

(30) Foreign Application Priority Data
Feb. 21, 2022 (KR) 10-2022-0022196

(51) Int. Cl. G06N 3/04

(52) U.S. Cl. CPC G06N 3/049

(57) ABSTRACT

Provided is a neuromorphic system for synaptic learning in a spiking neural network (SNN)-based neuromorphic array structure. Control blocks including a post-synaptic neuron, which generates a post-neuron spike, are disposed on output lines of a synapse array to implement a spike timing dependent plasticity (STDP) operation such that synaptic learning can be stably implemented in an SNN neuromorphic array. Also, a lateral inhibition circuit may be added. When a post-neuron spike is generated by an STDP control block connected to any one output line, the lateral inhibition circuit inhibits STDP control blocks connected to other output lines from generating spikes. Accordingly, learning selectivity can be improved, and thus the performance of an STDP algorithm can be improved.

### CROSS REFERENCE TO RELATED APPLICATION

This application claims priority to Korean Patent Application No. 10-2022-0022196, filed on Feb. 21, 2022 which is hereby incorporated by reference in its entirety.

### BACKGROUND

### 1. Field of the Invention

The present invention relates to a neuromorphic system for implementing a spike timing dependent plasticity (STDP) operation which is used for synaptic learning in a spiking neural network (SNN)-based neuromorphic array structure.

### 2. Discussion of Related Art

A neuromorphic chip is configured as a spiking neural network (SNN). The SNN fires only when the membrane potential of a neuron is higher than a threshold voltage, and transmits information between synapses through a fired spike. Accordingly, the SNN may operate with low power compared to other artificial neural networks. The SNN may learn the weight of a synapse using a spike timing dependent plasticity (STDP) algorithm.

FIG. 1 is a graph showing an operation characteristic of general STDP.

As shown in FIG. 1, according to STDP, the degree of learning of a synapse is generally determined according to a time difference between a spike generated by a presynaptic neuron circuit and a spike generated by a postsynaptic neuron circuit. When a presynaptic spike arrives within a specific window earlier than a postsynaptic spike, the connection between neurons is strengthened. On the other hand, when a postsynaptic spike arrives earlier than a presynaptic spike, the connection is weakened. This phenomenon has been extensively verified through biological experiments and is widely used as a learning method in spiking-based brain simulation.

### SUMMARY

The present invention is directed to providing a neuromorphic system for implementing a spike timing dependent plasticity (STDP) operation which is used for synaptic learning in a spiking neural network (SNN)-based neuromorphic array structure.

The present invention is also directed to providing a neuromorphic system for enhancing STDP operation performance by improving synaptic learning selectivity in an SNN-based neuromorphic system.

According to an aspect of the present invention, there is provided a neuromorphic system for implementing an STDP operation, the neuromorphic system including a presynaptic neuron configured to output a pre-neuron spike; a first signal generator configured to transform the pre-neuron spike output from the pre-synaptic neuron into a pre-neuron signal available for synaptic learning and output the pre-neuron signal, a first driver configured to output the pre-neuron signal output from the first signal generator, synapse units configured to receive the pre-neuron signal output from the first driver, and STDP control blocks configured to generate a post-neuron spike in response to the pre-neuron signal input through the synapse units, transform the generated post-neuron spike into a post-neuron signal available for synaptic learning and output the post-neuron signal to the synapse unit.

Each of the synapse units may include a memristor or a memtransistor connected between an input line connected to an output terminal of the first driver and an output line which is disposed to cross the input line and through which the pre-neuron signal output from the synapse unit is output to the STDP control block, and a transistor connected to the memristor or the memtransistor.

A drain terminal of the transistor may be connected to the input line, a source terminal may be connected to one end of the memristor or the memtransistor, and a gate terminal may be connected to a driving line such that the transistor may be selected and driven by a driving voltage applied through the driving line and the other end of the memristor or the memtransistor may be connected to the output line.

Each of the STDP control blocks may include a first transmission gate configured to transmit the pre-neuron signal passing through the synapse unit and output through the output line, a membrane capacitor configured to be charged with a membrane potential by the pre-neuron signal transmitted through the first transmission gate, a post-synaptic neuron configured to output the post-neuron spike according to the membrane potential charged in the membrane capacity, a second signal generator configured to transform the post-neuron spike output from the post-synaptic neuron into the post-neuron signal available for synaptic learning and output the post-neuron signal, a second driver configured to output the post-neuron signal output from the second signal generator to the synapse unit through the output line, and a second transmission gate configured to transmit the post-neuron signal output from the second driver to the output line in response to the post-neuron signal output from the second signal generator.

The first transmission gate may transmit the pre-neuron signal, which passes through the synapse unit and is output through the output line, to the membrane capacitor in response to the post-neuron signal output from the second signal generator.

Each of the first and second transmission gates may include an n-channel metal oxide semiconductor (NMOS) transistor and a p-channel metal oxide semiconductor (PMOS) transistor of which drain and source terminals are connected to each other.

The STDP control blocks may further include a first inverter configured to invert the post-neuron signal output from the second signal generator and output the inverted post-neuron signal to a gate terminal of the NMOS transistor of the first transmission gate and a gate terminal of the PMOS transistor of the second transmission gate, a second inverter configured to invert the signal output from the first inverter and output the inverted signal to a gate terminal of the PMOS transistor of the first transmission gate, and a buffer configured to output the post-neuron signal output from the second signal generator to a gate terminal of the NMOS transistor of the second transmission gate.

The neuromorphic system may further include a lateral inhibition circuit configured to inhibit, when the post-neuron signal is generated from any one STDP control block connected to the output line among the STDP control blocks, driving of the second signal generators of the other STDP control blocks connected to the other output lines so that no post-neuron signal is generated by the other STDP control blocks connected to the other output lines.

The pre-neuron signal or the post-neuron signal may have a square-wave form, a triangular-wave form or a sawtooth-wave form.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a graph showing an operation characteristic of general spike timing dependent plasticity (STDP);

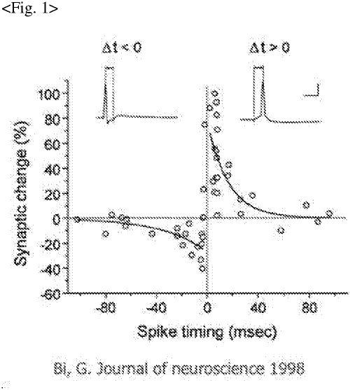

FIG. 2 is a diagram schematically showing a neuromorphic system according to an exemplary embodiment of the present invention;

FIG. 3 is an enlarged view schematically showing a portion of the configuration of FIG. 2;

FIG. 4 is a diagram schematically showing the configuration of an STDP control block shown in FIG. 2;

FIG. 5 is a diagram schematically showing operation waveforms of the STDP control block shown in FIG. 4;

FIG. 6 is a conceptual diagram illustrating synaptic connection strength of an STDP;

FIG. 7 is a diagram schematically showing a neuromorphic system according to another exemplary embodiment of the present invention; and

FIG. 8 is a diagram showing a lateral inhibition signal which is input to the STDP control block shown in FIG. 4.

### DETAILED DESCRIPTION

Hereinafter, advantages and features of the present invention and methods of achieving the same will be made clear by referring to exemplary embodiments described in detail with reference to the accompanying drawings. However, the present invention is not limited to the exemplary embodiments disclosed herein and may be implemented in various forms. The exemplary embodiments are only provided so that this disclosure of the present invention will fully convey the scope of the present invention to those of ordinary skill in the art. The present invention is only defined by the scope of the claims.

Terms used herein are intended to describe the exemplary embodiments and not to limit the present invention. In this specification, the singular forms include the plural forms as well unless the context clearly indicates otherwise. As used herein, the terms “include (or have)” and/or “including (or having)” do not preclude the presence or addition of one or more components or operations other than stated components or operations. Throughout the specification, like reference numerals refer to like elements. “And/or” includes each of stated items and all combinations of one or more thereof.

Unless otherwise defined, all terms (including technical and scientific terms) used herein have the same meanings as commonly understood by those of ordinary skill in the art. Also, terms defined in commonly used dictionaries will not be interpreted in an idealized or overly formal sense unless clearly so defined herein.

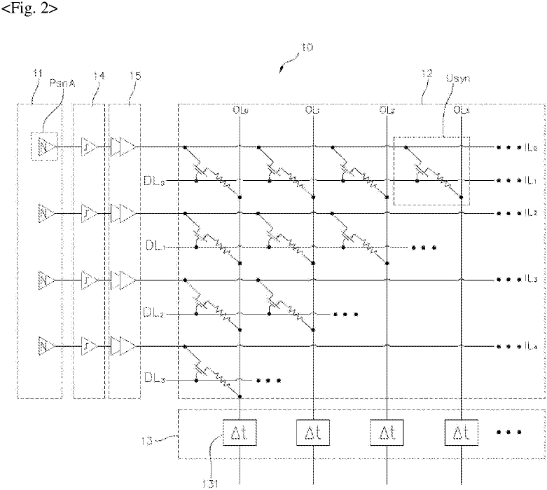

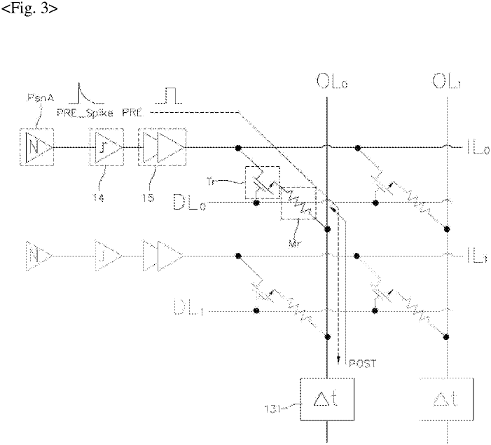

FIG. 2 is a diagram schematically showing a neuromorphic system according to an exemplary embodiment of the present invention, and FIG. 3 is an enlarged view schematically showing a portion of the configuration of FIG. 2.

Referring to FIGS. 2 and 3, a neuromorphic system 10 according to the exemplary embodiment of the present invention includes a spike timing dependent plasticity (STDP) implementation circuit 13 for implementing an STDP operation for synaptic learning in a spiking neural network (SNN)-based neuromorphic array structure including a neuron array 11 and a synapse array 12.

The neuron array 11 may include at least one neuron device based on a new material (hereinafter “pre-synaptic neuron (PsnA)). The pre-synaptic neuron PsnA is a neuron device based on a new material, which is not limited.

A pre-neuron spike PRE_Spike output from the pre-synaptic neuron PsnA is input to a signal regeneration circuit (hereinafter “first signal generator 14”) and transformed into, that is, regenerated as, a desired signal suitable for synaptic learning, that is, a signal available for synaptic learning. The first signal generator 14 regenerates and outputs the pre-neuron spike PRE_Spike as a desired signal suitable for synaptic learning. The signal (hereinafter “pre-neuron signal PRE”) regenerated through the first signal generator 14 is transmitted to the synapse array 12 through a first driver 15.

First signal generators 14 and pre-synaptic neurons PsnA are installed on a one-to-one basis, and a first signal generator 14 regenerates a pre-neuron signal PRE suitable for synaptic learning from a pre-neuron spike PRE_Spike output from each pre-synaptic neuron PsnA and outputs the pre-neuron signal PRE.

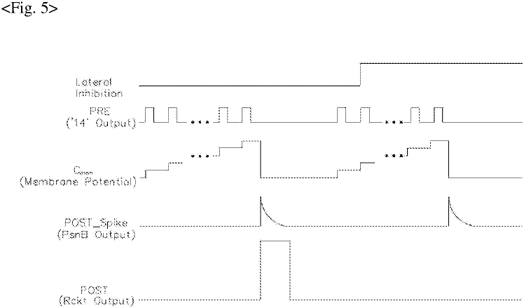

The pre-synaptic neurons PsnA included in the neuron array 11 are neuron devices manufactured on the basis of a new external material. The pre-synaptic neurons PsnA are manufactured with various new materials and thus may have different operation characteristics. For this reason, the pre-neuron spike PRE_Spike is transformed into, that is, regenerated as, the pre-neuron signal PRE has a square-wave form, a triangular-wave form or a sawtooth-wave form...suitable for synaptic learning through the first signal generator 14. An example of the pre-neuron signal PRE is shown in FIG. 5.

The synapse array 12 includes a plurality of input lines IL₀ to IL₄ and a plurality of output lines OL₀ to OL₄ disposed in a matrix form and synapse units Usyn disposed between the input lines IL₀ to IL₄ and between the output lines OL₀ to OL₄ and driven by driving lines DL₀ to DL₃. The number of input lines IL₀ to IL₄, the number of output lines OL₀ to OL₄, the number of driving lines DL₀ to DL₃, and the number of synapse units Usyn may be increased or decreased depending on the size of the synapse array 12.

As shown in FIG. 3, the synapse unit Usyn may include a memristor or a device that implements synaptic properties such as memtransistor having a variable resistance value and one end connected to an output line and a transistor Tr which is connected to the other end of the memristor and receives at least two input signals. The resistance value of the memristor Mr may vary depending on a difference between times at which the two input signals are input to the transistor Tr.

The resistance value of the memristor Mr included in the synapse unit Usyn may vary for synaptic learning depending on a voltage change caused by the time difference between first and second input signals which are the two input signals. As shown in FIG. 3, the first input signal may be the pre-neuron signal PRE applied to the drain terminal of the transistor Tr, and the second input signal may be a signal (hereinafter “post neuron signal POST”) output from the STDP implementation circuit 13 on the basis of a membrane voltage applied to the source terminal of the transistor Tr.

A driving voltage is applied to the gate terminal of the transistor Tr through the driving lines DL₀ to DL₃. The transistor Tr may be selected and driven by the driving voltage applied to the gate terminal.

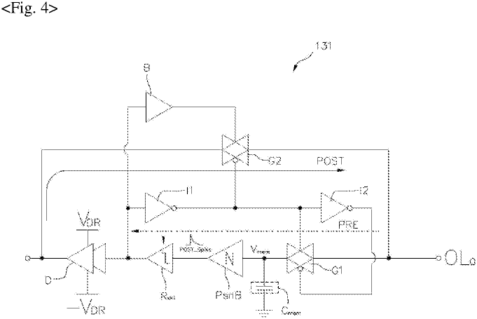

FIG. 4 is a diagram schematically showing the configuration of an STDP control block shown in FIG. 2, and FIG. 5 is a diagram schematically showing operation waveforms of the STDP control block shown in FIG. 4.

Referring to FIGS. 3 and 4, the STDP implementation circuit 13 according to the present invention includes one or more STDP control blocks 131 each disposed on the output lines OL₀ to OL₃ of the synapse array 12.

The STDP control block 131 includes a first transmission gate G1 that receives the pre-neuron signal PRE output from the synapse unit Usyn through the output line OL₀ and transmits the pre-neuron signal PRE to a back end. The first transmission gate G1 may include an n-channel metal oxide semiconductor (NMOS) transistor and a p-channel metal oxide semiconductor (PMOS) transistor of which drain and source terminals are connected to each other.

As shown in FIG. 5, the pre-neuron signal PRE may be, for example, a square-wave pulse. The pre-neuron signal PRE is transmitted to the membrane capacitor Cₘₑₘ such that the membrane capacitor Cₘₑₘ is charged. A membrane potential charged in the membrane capacitor Cₘₑₘ is shown in FIG. 5.

As shown in FIG. 5, when the membrane potential of the membrane capacitor Cₘₑₘ rises due to the pre-neuron signal PRE input in a square-wave form and exceeds an operating voltage of a post-synaptic neuron PsnB, the post-synaptic neuron PsnB outputs a post-neuron spike POST_Spike.

As shown in FIG. 4, the post-neuron spike POST-Spike generated by the post-synaptic neuron PsnB is regenerated through a second signal generator R_{ckt} as a post-neuron signal POST in a square-wave form suitable for synaptic learning and then output to the synapse unit Usyn through a second driver D.

As shown in FIG. 4, the STDP control block 131 includes a second transmission gate G2 that transmits the post-neuron signal POST output from the second driver D to the synapse unit Usyn as feedback. Like the first transmission gate G1, the second transmission gate G2 may include an NMOS transistor and a PMOS transistor of which drain and source terminals are connected to each other. The second transmission gate G2 outputs the post-neuron signal POST to the synapse unit Usyn in response to the output signal generated by the second signal generator R_{ckt}.

To control the operation of the second transmission gate G2, the STDP control block 131 may additionally include a buffer B for transmitting the output signal of the second signal generator R_{ckt} and a first inverter I1 for inverting the output signal of the second signal generator R_{ckt}. Also, to control the operation of the first transmission gate G1, the STDP control block 131 may additionally include a second inverter I2 for inverting an output of the first inverter I1. The first transmission gate G1 transmits the pre-neuron signal PRE input through the output line OL₀ to the membrane capacitor Cₘₑₘ according to output signals of the first inverter I1 and the second inverter I2.

To implement an STDP operation, it is necessary to change a membrane voltage Vₘₑₘ. The membrane voltage Vₘₑₘ may be changed by changing the capacitance of the membrane capacitor Cₘₑₘ or changing a driving voltage, current, etc. of the second driver D.

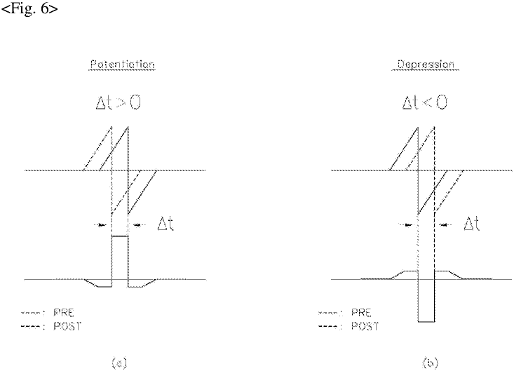

FIG. 6 is a conceptual diagram illustrating synaptic connection strength of an STDP.

As shown in FIG. 6, when the post neuron signal POST is output after the pre-neuron signal PRE is output, a synaptic connection is potentiated. On the other hand, when the pre-neuron signal PRE is output after the post neuron signal POST is output, the synaptic connection is depressed.

Meanwhile, to improve the performance of an STDP algorithm, the neuromorphic system 10 according to the exemplary embodiment of the present invention inhibits a post-neuron spike from being generated from another output line (column line) when one post-neuron signal POST is generated such that synaptic learning selectivity can be improved.

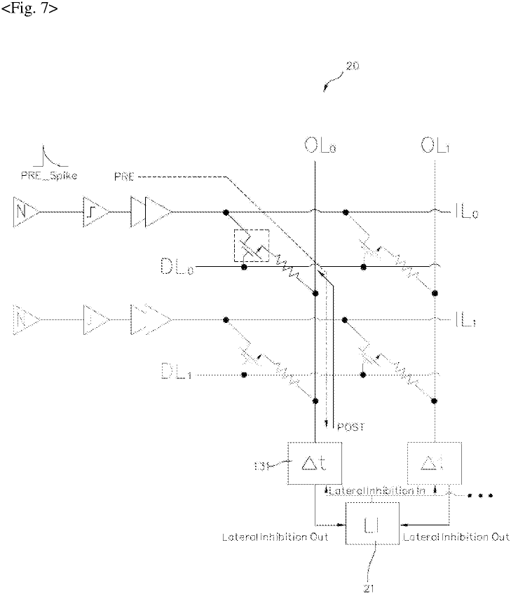

FIG. 7 is a diagram schematically showing a neuromorphic system according to another exemplary embodiment of the present invention.

Referring to FIG. 7, a neuromorphic system 20 according to the other exemplary embodiment of the present invention includes the configuration of the neuromorphic system 10 shown in FIGS. 2 and 3 and additionally includes a lateral inhibition circuit 21 that may improve synaptic learning selectivity by inhibiting a spike from being generated from another output line when any one post-neuron spike is generated.

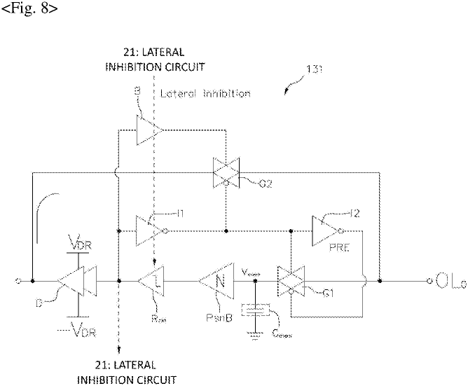

FIG. 8 is a diagram showing a lateral inhibition signal which is input to the STDP control block shown in FIG. 4.

Referring to FIGS. 7 and 8, when a post-neuron spike is generated by an STDP control block connected to any one output line OL₀ and a post-neuron signal is output, the lateral inhibition circuit 21 transmits a lateral inhibition signal to the second signal generators R_{ckt} of the STDP control blocks connected to the other output lines OL₁ to OL₃ so that no post-neuron signal is output from the STDP control blocks connected to the other output lines OL₁ to OL₃.

As described above, according to the present invention, it is possible to stably implement synaptic learning in an SNN neuromorphic array by separately arranging STDP control blocks including post-synaptic neurons which generate a post-neuron spike on output lines of a synapse array.

Also, according to the present invention, a lateral inhibition circuit is added. When a post-neuron spike is generated by an STDP control block connected to any one output line, STDP control blocks connected to other output lines are inhibited from generating a post-neuron spike. Accordingly, learning selectivity is improved, and thus the performance of an STDP algorithm can be enhanced.

Although exemplary embodiments of the present invention have been described and illustrated above using specific terms, the terms are only intended to clearly describe the present invention. It is obvious that various modifications and alterations can be made from the embodiments of the present invention and the terms without departing from the technical spirit and scope of the following claims. The modified embodiments should not be understood separately from the spirit and scope of the present invention and should be considered as falling within the scope of the claims of the present invention.

What is claimed is:

1. A neuromorphic system for implementing a spike timing dependent plasticity (STDP) operation, the neuromorphic system comprising:
a pre-synaptic neuron configured to output a pre-neuron spike;
a first signal generator configured to transform the pre-neuron spike output from the pre-synaptic neuron into a pre-neuron signal available for synaptic learning and output the pre-neuron signal;
a first driver configured to output the pre-neuron signal output from the first signal generator;
synapse units configured to receive the pre-neuron signal output from the first driver; and
STDP control blocks configured to generate a post-neuron spike in response to the pre-neuron signal input through the synapse units, transform the generated post-neuron spike into a post-neuron signal available for synaptic learning and output the post-neuron signal to the synapse unit.

2. The neuromorphic system of claim 1, wherein each of the synapse units comprises:
a memristor or a memtransistor connected between an input line connected to an output terminal of the first driver and an output line which is disposed to cross the input line and through which the pre-neuron signal output from the synapse unit is output to the STDP control block; and
a transistor connected to the a memristor or a memtransistor.

3. The neuromorphic system of claim 2, wherein a drain terminal of the transistor is connected to the input line,
a source terminal is connected to one end of the a memristor or a memtransistor, and
a gate terminal is connected to a driving line such that the transistor is selected and driven by a driving voltage applied through the driving line and another end of the memristor or the memtransistor is connected to the output line.

4. The neuromorphic system of claim 2, wherein each of the STDP control blocks comprises:
a first transmission gate configured to transmit the pre-neuron signal passing through the synapse unit and output through the output line;
a membrane capacitor configured to be charged with a membrane potential by the pre-neuron signal transmitted through the first transmission gate;
a post-synaptic neuron configured to output the post-neuron spike according to the membrane potential charged in the membrane capacity;
a second signal generator configured to transform the post-neuron spike output from the post-synaptic neuron into the post-neuron signal available for synaptic learning and output the post-neuron signal;
a second driver configured to output the post-neuron signal output from the second signal generator to the synapse unit through the output line; and
a second transmission gate configured to transmit the post-neuron signal output from the second driver to the output line in response to the post-neuron signal output from the second signal generator.

5. The neuromorphic system of claim 4, wherein the first transmission gate transmits the pre-neuron signal, which passes through the synapse unit and is output through the output line, to the membrane capacitor in response to the post-neuron signal output from the second signal generator.

6. The neuromorphic system of claim 4, wherein each of the first and second transmission gates comprises an n-channel metal oxide semiconductor (NMOS) transistor and a p-channel metal oxide semiconductor (PMOS) transistor of which drain and source terminals are connected to each other.

7. The neuromorphic system of claim 6, wherein each of the STDP control blocks further comprises:
a first inverter configured to invert the post-neuron signal output from the second signal generator and output the inverted post-neuron signal to a gate terminal of the NMOS transistor of the first transmission gate and a gate terminal of the PMOS transistor of the second transmission gate;
a second inverter configured to invert the signal output from the first inverter and output the inverted signal to a gate terminal of the PMOS transistor of the first transmission gate; and
a buffer configured to output the post-neuron signal output from the second signal generator to a gate terminal of the NMOS transistor of the second transmission gate.

8. The neuromorphic system of claim 2, further comprising a lateral inhibition circuit configured to inhibit, when the post-neuron signal is generated from any one STDP control block connected to the output line among the STDP control blocks, driving of the second signal generators of the other STDP control blocks connected to the other output lines so that no post-neuron signal is generated by the other STDP control blocks connected to the other output lines.

9. The neuromorphic system of claim 1, wherein the pre-neuron signal or the post-neuron signal has a square-wave form, a triangular-wave form or a sawtooth-wave form.
